(19) United States
(12) Patent Application Publication
(10) Pub. No.: US 2025/0023273 A1
(43) Pub. Date: Jan. 16, 2025

(54) CONNECTOR

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventor: Shingo KOBAYASHI, Mie (JP)

(21) Appl. No.: 18/712,064

(22) PCT Filed: Nov. 15, 2022
(86) PCT No.: PCT/JP2022/042305

§ 371 Date: May 21, 2024

(30) Foreign Application Priority Data
Dec. 3, 2021 (JP) 2021-196931

(51) Int. Cl. H01R 13/17; H01R 13/436; H01R 13/502

(52) U.S. Cl. CPC H01R 13/17; H01R 13/4361; H01R 13/502

(57) ABSTRACT

A connector includes a strip-like electrically conductive member including a first end part connectable to a mating terminal, a connector housing for accommodating the electrically conductive member, a clip spring separate from the electrically conductive member, the clip spring accommodating the first end part, and a clip stopper mounted on the electrically conductive member, the clip stopper limiting a displacement of the clip spring with respect to the electrically conductive member. The connector housing includes a wall provided with an opening enabling insertion of the mating terminal in a first direction along a longitudinal direction of the electrically conductive member to connect the mating terminal to the first end part. The clip spring includes a first resilient piece and a second resilient piece capable of sandwiching the first end part and the mating terminal with the mating terminal inserted through the opening overlapped on the first end part.

### TECHNICAL FIELD

The present disclosure relates to a connector.

This application is based on Japanese Patent Application No. 2021-196931 filed with the Japan Patent Office on Dec. 3, 2021, the contents of which are hereby incorporated by reference.

### BACKGROUND

To connect two electrical devices such as a motor and an inverter, a wiring harness is conventionally used. For a reduction in the number of components and space saving, a structure for directly connecting the electrical devices has been proposed (for example, Patent Document 1). For that structure, one electrical device includes a first connector and the other electrical device includes a second connector connectable to the first connector.

### PRIOR ART DOCUMENT

### Patent Document

Patent Document 1: JP 2010-225488 A

### SUMMARY OF THE INVENTION

A connector according to one aspect of the present disclosure is a connector electrically connectable to a mating connector provided with a mating terminal, the connector being provided with a strip-like electrically conductive member including a first end part connectable to the mating terminal, a connector housing for accommodating the electrically conductive member, a clip spring separate from the electrically conductive member, the clip spring accommodating the first end part, and a clip stopper mounted on the electrically conductive member, the clip stopper limiting a displacement of the clip spring with respect to the electrically conductive member, the connector housing including a wall provided with an opening enabling insertion of the mating terminal in a first direction along a longitudinal direction of the electrically conductive member to connect the mating terminal to the first end part, the clip spring including a first resilient piece and a second resilient piece capable of sandwiching the first end part and the mating terminal with the mating terminal inserted through the opening overlapped on the first end part, and the clip stopper including a locking portion to be locked to the electrically conductive member and a stopper portion capable of contacting the clip spring being displaced in the first direction.

### BRIEF DESCRIPTION OF THE DRAWINGS

FIG. 1 is a perspective view of a connector and a mating connector according to an embodiment.

FIG. 2 is a perspective view of the connector and the mating connector according to the embodiment.

FIG. 3 is an exploded perspective view of the connector and the mating connector.

FIG. 4 is a perspective view partially in section showing the connector.

FIG. 5 is a perspective view of electrically conductive members, clip springs and clip stoppers in a disassembled state.

FIG. 6 is a section of the connector.

FIG. 7 is a section showing a connected state of the electrically conductive member and a mating terminal.

FIG. 8 is a perspective view showing the connector with restricting members removed.

FIG. 9 is a perspective view of the electrically conductive member and the clip stopper.

FIG. 10 is a diagram showing the clip spring and the clip stopper.

FIG. 11 is a diagram showing a state where the clip spring is removed from the clip stopper.

FIG. 12 is a diagram showing a modification of a clip stopper.

FIG. 13A is a perspective view showing a modification of the restricting member.

FIG. 13B is a perspective view showing a modification of the restricting member.

FIG. 14A is a perspective view showing a modification of the restricting member.

FIG. 14B is a perspective view showing a modification of the restricting member.

### DETAILED DESCRIPTION TO EXECUTE THE INVENTION

### Technical Problem

The connector disclosed in Patent Document 1 is provided with a terminal fitting, a connector housing and a supporting member to be mounted into the connector housing. The terminal fitting includes a first end part (electrical contact portion) connectable to a mating terminal of a mating connector, a second end part (device connecting portion) on an opposite side and a braided wire linking a first terminal and a second terminal. The supporting member displaceably supports the first end part (electrical contact portion) in the connector housing.

Even if the first end part of the connector deviates in relation to the mating terminal of the mating connector, the first end part is displaced and the braided wire is deflected, whereby such a positional deviation is absorbed and the electrical devices are electrically connected.

In the case of the above connector, the braided wire needs to be joined to the first and second end parts and hardly contributes to a cost reduction.

If the mating terminal pushes the first terminal in an operation of connecting the mating terminal to the first end part of the connector, there is a possibility that the first terminal escapes (retreats) as the braided wire is deflected, and the connecting operation may be difficult in some cases.

Accordingly, the present disclosure aims to enable an electrical connection and facilitate such a connection by absorbing a positional deviation even if there is the positional deviation between a connector and a mating connector.

### Effect of Present Disclosure

According to the present disclosure, it is possible to enable an electrical connection and facilitate such a connection by absorbing a positional deviation even if there is the positional deviation between a connector and a mating connector.

### SUMMARY OF EMBODIMENTS OF PRESENT DISCLOSURE

Hereinafter, summaries of embodiments of the present disclosure are listed and described.

(1) The connector of an embodiment is electrically connectable to a mating connector provided with a mating terminal, and provided with a strip-like electrically conductive member including a first end part connectable to the mating terminal, a connector housing for accommodating the electrically conductive member, a clip spring separate from the electrically conductive member, the clip spring accommodating the first end part, and a clip stopper mounted on the electrically conductive member, the clip stopper limiting a displacement of the clip spring with respect to the electrically conductive member, the connector housing including a wall provided with an opening enabling insertion of the mating terminal in a first direction along a longitudinal direction of the electrically conductive member to connect the mating terminal to the first end part, the clip spring including a first resilient piece and a second resilient piece capable of sandwiching the first end part and the mating terminal with the mating terminal inserted through the opening overlapped on the first end part, and the clip stopper including a locking portion to be locked to the electrically conductive member and a stopper portion capable of contacting the clip spring being displaced in the first direction.

According to the connector of this embodiment, the first end part of the electrically conductive member is accommodated in the clip spring, and the mating terminal is inserted through the opening of the connector housing to be connected to the first end part. At that time, even if there is a slight positional deviation between the first end part and the mating terminal, a part of the strip-like electrically conductive member is resiliently deformed, whereby that positional deviation can be absorbed. Further, the mating terminal is brought closer to and brought into contact with the clip spring through the opening along the first direction to connect the first end part and the mating terminal accommodated in the clip spring. Then, the clip spring is displaced in the first direction. The clip stopper is locked to the electrically conductive member by the locking portion, thereby being non-displaceable in the first direction with respect to the electrically conductive member, and the clip spring contacts the stopper portion of the clip stopper. As a result, the clip spring does not escape in the first direction, and the first end part and the mating terminal are easily connected.

(2) Preferably, the clip stopper includes a first stopper portion capable of contacting the first resilient piece and a second stopper portion capable of contacting the second resilient pieces as the stopper portions. By this configuration, when the first end part and the mating terminal are connected, the clip stopper contacts both the first and second resilient pieces of the clip spring and the posture of the clip spring hardly changes. The first end part and the mating terminal are more easily connected.

(3) Preferably, the clip stopper includes a first locking portion to be locked on one side in a width direction orthogonal to the first direction and a second locking portion to be locked on the other side in the width direction as the locking portions. By this configuration, the clip stopper is hardly inclined with respect to the electrically conductive member, and the clip spring can be stably supported.

(4) Preferably, the clip stopper includes a first supporting piece located between the first and second resilient pieces and adjacent to the first end part in the width direction orthogonal to the first direction and, if a direction of overlapping the first end part and the mating terminal in the clip spring is an overlapping direction, the first resilient piece is capable of contacting one end in the overlapping direction of the first supporting piece, the second resilient piece is capable of contacting the other end in the overlapping direction of the first supporting piece, the first end part is located on a side near the second resilient piece, out of a clip space formed between the first and second resilient pieces, and a space for insertion of the mating terminal is formed on a side near the first resilient piece, out of the clip space.

According to this configuration, the space for the insertion of the mating terminal is formed between the first end part and the first resilient piece by the first supporting piece. With the mating terminal overlapped on and connected to the first end part, the first resilient piece contacts the mating terminal, the second resilient piece contacts the first end part and the clip spring sandwiches the first end part and the mating terminal.

(5) Preferably, in the connector of (4) described above, a dimension in the overlapping direction of the first supporting piece is smaller than a first dimension in the overlapping direction of the first end part and the mating terminal overlapped by the clip spring and larger than a second dimension in the overlapping direction of the first end part in a single state, and the first and second resilient pieces resiliently sandwich the first supporting piece in a state where the mating terminal is not overlapped on the first end part.

According to this configuration, since the dimension in the overlapping direction of the first supporting piece is smaller than the first dimension of the first end part and the mating terminal in the overlapped state, the first end part and the mating terminal are resiliently sandwiched by the first and second resilient pieces.

Since the dimension in the overlapping direction of the first supporting piece is larger than the second dimension of the first end part in the single state and the first and second resilient pieces resiliently sandwich the first supporting piece in the state where the mating terminal is not overlapped on the first end part, a space for the insertion of the mating terminal to be overlapped on the first end part is secured between the first and second resilient pieces. Thus, a force required to insert and mount the mating terminal into the clip spring is reduced.

(6) Preferably, in the connector of (4) or (5) described above, the clip spring includes a clip base part located adjacent to the first end part in the width direction, the first and second resilient pieces are respectively provided to extend in the width direction from both ends in the overlapping direction of the clip base part, the clip stopper includes a stopper base part located on the first direction side of the clip spring and a second supporting piece located on a side opposite to the first supporting piece across the first end part, the first and second supporting pieces are respectively provided to extend in a direction opposite to the first direction from both ends in the width direction of the stopper base part, and a pair of structures each including the electrically conductive member, the clip spring and the clip stopper are plane-symmetrically arranged with respect to a center in the width direction of the connector housing on both sides in the width direction of the connector housing.

According to this configuration, the clip stopper can be used as a common component for each of the pair of structures arranged on the both widthwise sides of the connector housing.

(7) Preferably, in the connector of (6) described above, the clip base parts are arranged apart on outer sides in the width direction in two structures arranged on the both sides in the width direction of the connector housing. According to this configuration, parts of the clip springs of the two structures for sandwiching the first end parts and the mating terminals can be arranged closely in the width direction. As a result, two first end parts can be brought closer to each other and two mating terminals can be brought closer to each other in the width direction, which contributes to making the mating connector compact in the width direction.

(8) Preferably, the clip stopper includes a detachment preventing stopper portion capable of contacting the clip spring from the first direction. According to this configuration, a displacement of the clip spring also in the direction opposite to the first direction is limited. In the case of pulling out the mating terminal from the clip spring, the clip spring is held by the clip stopper.

(9) Preferably, the electrically conductive member includes a second end part located on a side opposite to the first end part in the longitudinal direction of the electrically conductive member, and a damper portion provided between the first and second end parts, the damper portion being resiliently deformable in a direction to bring the first and second end parts closer. By this configuration, even if there is a positional deviation between the first end part and the mating terminal when the mating terminal inserted through the opening of the housing is connected to the first end part of the electrically conductive member of the connector, that positional deviation can be absorbed by the resilient deformation of the damper portion.

(10) Preferably, the connector of (9) described above is further provided with a restricting member provided in the connector housing, and the restricting member is provided in a region adjacent to the first end part in the first direction to limit a displacement of the first end part when the damper portion is resiliently deformed. By this configuration, a resilient deformation amount of the damper portion caused by a force for mechanically connecting the first end part and the mating terminal is limited by limiting the displacement of the first end part by the restricting member provided in the region adjacent to the first end part. As a result, the first end part and the mating terminal are easily connected.

### Details of Embodiments of Present Disclosure

Hereinafter, embodiments of the present disclosure are described in detail with reference to the drawings. Note that at least some of embodiments described below may be arbitrarily combined.

### Concerning Connector 10 and Mating Connector 90

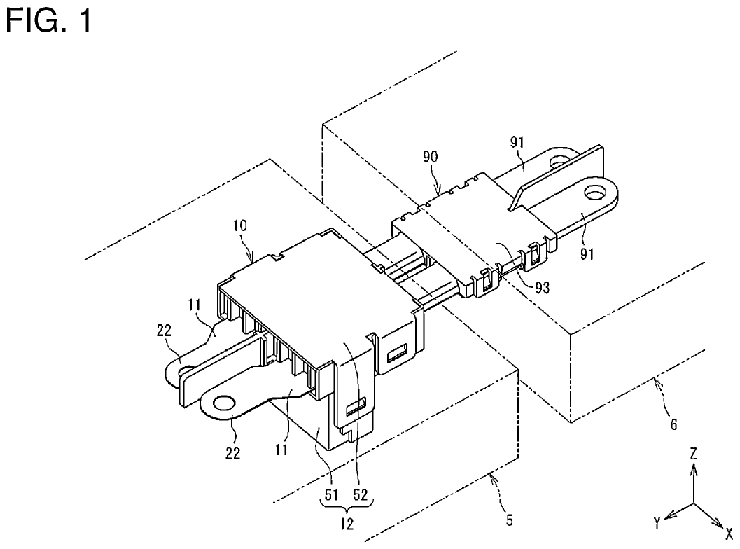

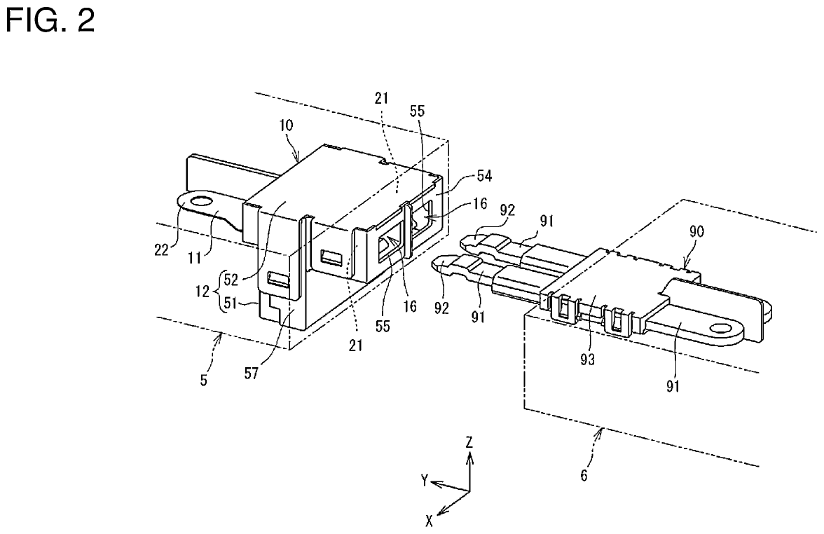

FIGS. 1 and 2 are perspective views of a connector 10 and a mating connector 90 according to an embodiment. FIG. 1 shows a state where the connector 10 and the mating connector 90 are connected. FIG. 2 shows a state where the connector 10 and the mating connector 90 are not connected. The connector 10 is a first connector of a first electrical device 5, and the mating connector 90 is a second connector of a second electrical device 6 separate from the first electrical device 5. The first and second electrical devices 5, 6 of this embodiment are in-vehicle devices of an automotive vehicle.

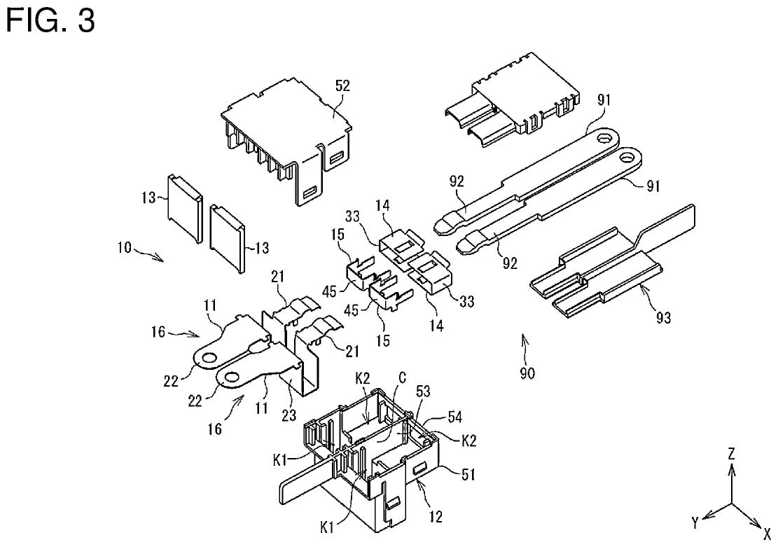

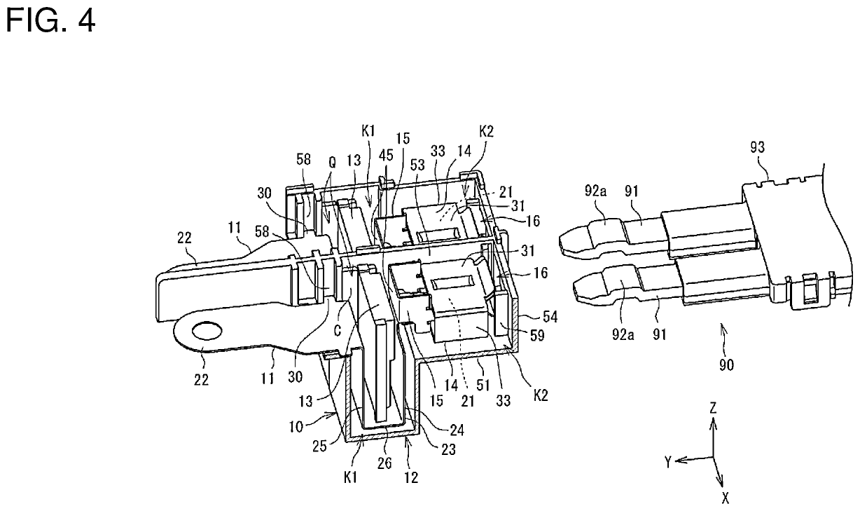

The first and second electrical devices 5, 6 are directly connected. That is, the connector 10 is directly connected to the mating connector 90 without via a wiring harness. The first and second electrical devices 5, 6 are shown by two-dot chain lines in FIGS. 1 and 2. FIG. 3 is an exploded perspective view of the connector 10 and the mating connector 90. FIG. 4 is a perspective view partially in section of the connector 10.

The connector 10 is provided with two strip-like electrically conductive members 11, 11 and one connector housing 12 for accommodating the electrically conductive members 11, 11. Each electrically conductive member 11 is constituted by one strip-like member having a bent portion.

The mating connector 90 is provided with two strip-like mating terminals 91, 91 and one mating housing 93 for accommodating the mating terminals 91, 91. One electrically conductive member 11 and one mating terminal 91 are electrically connected.

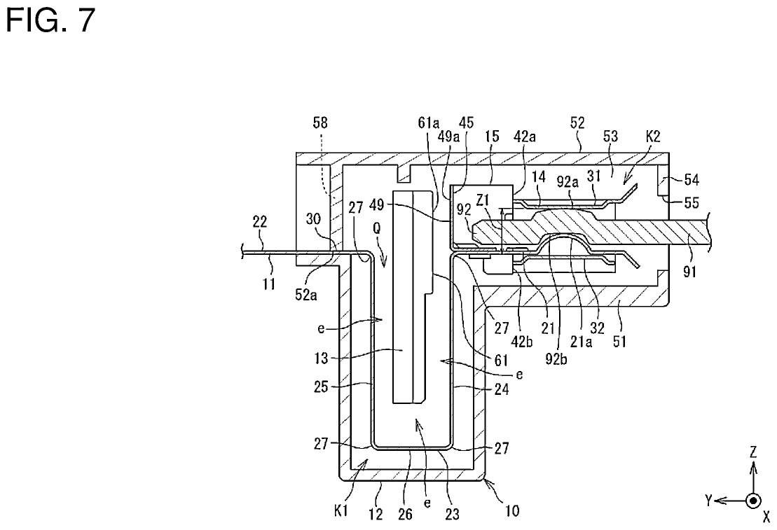

The electrically conductive member 11 is strip-like although including the bent portion, and includes a first end part 21 and a second end part 22 as parts extending long in one direction (see FIG. 3). The one direction is defined as a longitudinal direction of the electrically conductive member 11 and a direction along the longitudinal direction is defined as a “first direction”. The mating terminal 91 has a linear shape along the first direction. The two electrically conductive members 11, 11 are provided side by side in a direction orthogonal to the first direction. An arrangement direction of the two electrically conductive members 11, 11 is defined as a “width direction”. Although described later (see FIG. 7), the first end part 21 of the electrically conductive member 11 and a mating end part 92 of the mating terminal 91 are overlapped, whereby the electrically conductive member 11 and the mating terminal 91 are electrically connected. A direction of overlapping the mating terminal 91 (mating end part 92) on the first end part 21 is defined as an “overlapping direction”. The overlapping direction coincides with a direction orthogonal to both the first direction and the width direction.

XYZ orthogonal coordinates are shown in each figure. An X direction is the width direction (direction from one side toward the other side in the width direction), a Y direction is the first direction (direction from the side of the mating terminal 91 toward the electrically conductive member 11) and a Z direction is the overlapping direction (direction from the first end part 21 toward the mating end part 92).

### Concerning Connector 10

In FIG. 3, the connector 10 is provided with restricting members 13, clip springs 14 and clip stoppers 15 besides the electrically conductive members 11 and the connector housing 12. One structure 16 is constituted by one electrically conductive member 11, one clip spring 14 and one clip stopper 15. A pair of the structures 16, 16 are plane-symmetrically arranged with respect to a center C in the width direction of the connector housing 12 on both sides in the width direction of the connector housing 12. The first structure 16 on one widthwise side and the second structure 16 on the other widthwise side are configured plane-symmetrically with respect to a virtual plane extending in a Y-Z direction including the center C as described above, but the structure and function of each constituent element are the same.

### Electrically Conductive Members 11

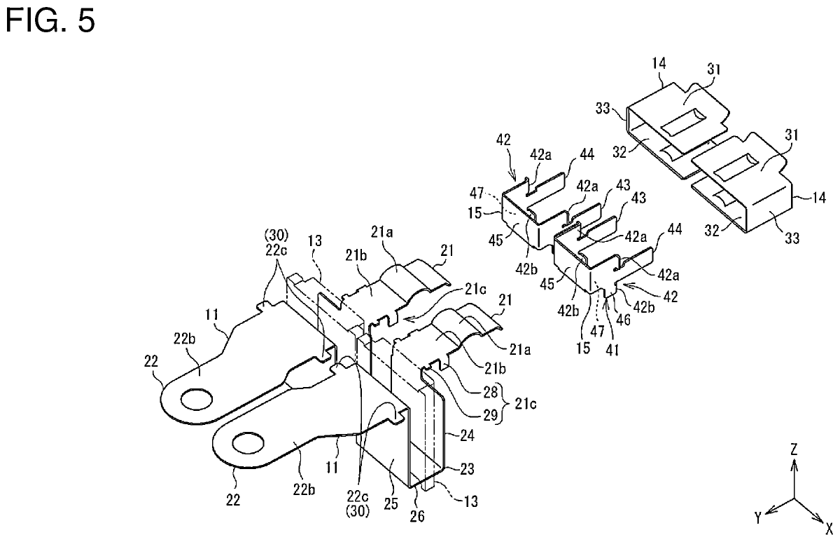

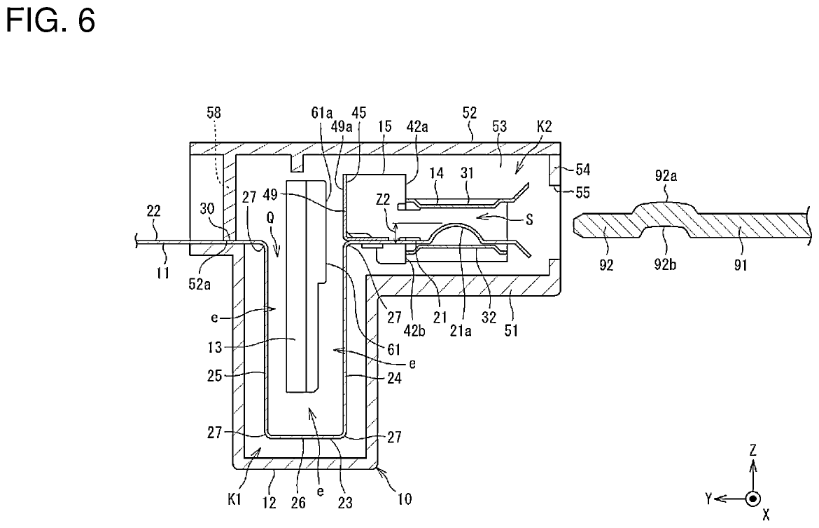

FIG. 5 is a perspective view of the electrically conductive members 11, the clip springs 14 and the clip stoppers 15 in a disassembled state. The restricting members 13 are shown by two-dot chain lines in FIG. 5. The electrically conductive member 11 is made of a strip-like electrically conductive metal plate material and also referred to as a busbar. The electrically conductive member 11 is, for example, made of copper alloy. The electrically conductive member 11 is a resilient strip piece allowed to be resiliently deformed and deflected in a thickness direction thereof. FIG. 6 is a section of the connector 10. FIG. 6 shows a state where the electrically conductive member 11 and the mating terminal 91 are not connected (non-connected state). FIG. 7 is a section showing a state where the electrically conductive member 11 and the mating terminal 91 are connected (connected state).

The electrically conductive member 11 includes the first end part 21, the second end part 22 and a damper portion 23. The first end part 21, the damper portion 23 and the second end part 22 are configured by bending a single resilient strip piece. The first end part 21 is a part electrically and mechanically connectable to the mating end part 92 of the mating terminal 91. The second end part 22 is a part located on a side opposite to the first end part 21 in the longitudinal direction of the electrically conductive member 11. The second end part 22 is connected to an unillustrated device-side terminal or the like.

The damper portion 23 is a part provided between the first and second end parts 21, 22. The damper portion 23 is resiliently deformable in directions for bringing the first and second end parts 21, 22 toward and away from each other. Not only the damper portion 23 is resiliently deformed, but also the first end part 21 is resiliently deformable to have a component of a thickness direction thereof (Z direction) and the second end part 22 is resiliently deformable to have a component of a thickness direction thereof (Z direction). Thus, the first and second end parts 21, 22 can be relatively displaced to have components of the Z direction. For example, one or both of the first and second end parts 21, 22 can be inclined with respect to the Y direction.

The damper portion 23 includes a first part 24, a second part 25 and a coupling portion 26. The first part 24 is a part connected to the first end part 21 and extending in a direction intersecting (orthogonal in the shown example) the Y direction. The second part 25 is a part connected to the second end part 22 and extending in a direction intersecting (orthogonal in the shown example) the Y direction. The coupling portion 26 is a part coupling the first and second parts 24, 25.

The first and second parts 24, 25 are arranged to face each other. The plate-like restricting member 13 is provided between the first and second parts 24, 25. In the non-connected state, the electrically conductive member 11 is in an initial state where no external force is applied and the electrically conductive member 11 is not resiliently deformed, i.e. in a free state. In the initial state, the restricting member 13 and the damper portion 23 are in a non-contact state.

Each of the first and second parts 24, 25 has a flat plate shape linearly extending in the Z direction. The coupling portion 26 has a flat plate shape coupling the first and second parts 24, 25 in the Y direction. Thus, the damper portion 23 includes bent portions 27 at four positions (see FIG. 6). Since the electrically conductive member 11 is resiliently deformable in each part, an angle of each of the bent portions 27 at the four positions can be changed. Although the shown electrically conductive member 11 is angularly bent at the bent portions 27, the electrically conductive member 11 may be curvedly bent.

The first end part 21 has a linear shape extending in the Y direction. The first end part 21 (see FIG. 5) includes a plate-like first body portion 21b and a first fixing portion 21c for fixing the clip stopper 15. The first body portion 21b includes a raised portion 21a raised in the Z direction at a halfway position. The first fixing portion 21c includes first claw portions 28 and second claw portions 29. The first claw portions 28 are bent in a direction opposite to the Z direction (downward in FIG. 5) respectively from both side parts in the width direction of the first body portion 21b. The second claw portions 29 are provided apart from the first claw portions 28 in the Y direction and project outward in the width direction from the both side parts in the width direction of the first body portion 21b. Locking portions 41 of the clip stopper 15 to be described later are locked to this first fixing portion 21c. In this way, the clip stopper 15 is mounted on the electrically conductive member 11 (first end part 21) non-displaceably in the X, Y and Z directions.

In FIG. 5, the second end part 22 has a shape extending in the Y direction. The second end part 22 includes a plate-like second body portion 22b and a second fixing portion 22c to be fixed to the connector housing 12. The second fixing portion 22c includes third claw portions 30 projecting outward in the width direction from both side parts in the width direction of the second body portion 22b. The third claw portions 30 are engaged with second mounting grooves 58 formed in a housing body 51 to be described later (see FIG. 4).

### Connector Housing 12

The connector housing 12 is made of resin. As shown in FIG. 3, the connector housing 12 includes the housing body 51 and a cover 52. The housing body 51 has a bottomed rectangular tube shape. The cover 52 is detachably attachable to the housing body 51. A space formed between the cover 52 and the housing body 51 serves as a space for accommodating the electrically conductive members 11, the restricting members 13, the clip springs 14 and the clip stoppers 15. Note that the second end parts 22 of the electrically conductive members 11 project in the Y direction from the connector housing 12 (see FIG. 4).

The housing body 51 includes a first space K1 for accommodating the damper portions 23 and the restricting members 13 and a second space K2 for accommodating the first end parts 21, the clip springs 14 and the clip stoppers 15. The housing body 51 includes a partition wall 53 in a widthwise center. The partition wall 53 partitions each of the first and second spaces K1, K2 into one side and the other side in the width direction. The partition wall 53 is provided along a virtual plane in a Y-Z direction including the center C in the width direction of the connector housing 12. The first structure 16 is provided on the one side in the width direction of the partition wall 53, and the second structure 16 is provided on the other side in the width direction of the partition wall 53.

The connector housing 12 (housing body 51) includes a wall 54 orthogonal to the Y direction (see FIG. 2). The wall 54 is provided with a pair of openings 55, 55 for the first structure 16 and for the second structure 16. Each opening 55 is constituted by a hole penetrating through the wall 54 in the Y direction. Each opening 55 enables the insertion of the mating end part 92 in the Y direction to connect the mating end part 92 of the mating terminal 91 to the first end part 21.

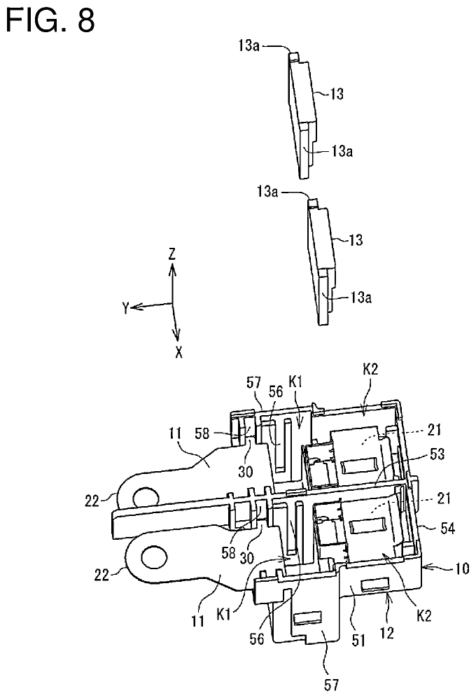

FIG. 8 is a perspective view showing the connector 10 with the restricting members 13 removed. The housing body 51 includes side walls 57, 57 on both sides in the width direction. Out of the connector housing 12, grooves 56 for mounting the restricting members 13 are provided in parts corresponding to the first space K1. Hereinafter, these grooves 56 are referred to as “first mounting grooves 56”. The first mounting grooves 56 are respectively formed in both surfaces of the partition wall 58 and the side walls 57, 57 on the both sides with the Z direction as a groove longitudinal direction.

The restricting member 13 is a plate-like member. The restricting member 13 becomes immovable in the Y direction by fitting and mounting side parts 13a in the width direction of the restricting member 13 into the first mounting grooves 56. By inserting the restricting member 13 along the first mounting grooves 56 into the housing body 51 with the cover 52 removed, the restricting member 13 can be mounted into the housing body 51. As just described, the restricting member 13 is insertable in a predetermined direction into the first mounting grooves 56, and can be mounted immovably in the first direction (Y direction) intersecting the predetermined direction.

The connector housing 12 is formed with the second mounting grooves 58 having a groove longitudinal direction along the Z direction. The third claw portions 30 of the second end part 22 of the electrically conductive member 11 are fit into the second mounting grooves 58. In this way, the second end part 22 becomes non-displaceable in the X and Y directions and opposite directions of the X and Y directions with respect to the connector housing 12. The third claw portions 30 are sandwiched in the Z direction by parts of the housing body 51 (back surfaces of the second mounting grooves 58) and a part 52a (see FIG. 6) of the cover 52. In this way, the second end part 22 becomes non-displaceable in the Z direction with respect to the connector housing 12. The electrically conductive member 11 is supported and restrained in the connector housing 12 at the second mounting grooves 58, which are parts in the Y direction of the connector housing 12, but is freely resiliently deformable and displaceable in the X, Y and Z directions in other parts.

### Clip Springs 14

As shown in FIG. 5, the clip spring 14 is a member separate from the electrically conductive member 11. The clip spring 14 is more resilient than the electrically conductive member 11 and, for example, made of stainless steel for spring. The clip spring 14 is capable of sandwiching the first end part 21 and the mating end part 92 of the mating terminal 91 (see FIG. 7). The clip spring 14 includes a clip base part 33 located adjacent to the first end part 21 in the X direction (or the direction opposite to the X direction) and a first resilient piece 31 and a second resilient piece 32 located on both sides in the Z direction of the first end part 21. The first and second resilient pieces 31, 32 are respectively provided to extend in the X direction (or the direction opposite to the X direction) from both ends in the Z direction of the clip base part 32. Each of the first and second resilient pieces 31, 32 is cantilevered from the clip base part 33.

In the non-connected state shown in FIG. 6, the clip spring 14 is in a state accommodating the first end part 21. That is, the first end part 21 is located between the first and second resilient pieces 31, 32. The mating end part 92 of the mating terminal 91 inserted through the opening 55 of the connector housing 12 is overlapped on the first end part 21. In the connected state shown in FIG. 7, the mating end part 92 is overlapped on the first end part 21 and the first and second resilient pieces 31, 32 sandwich the first end part 21 and the mating end part 92.

The clip spring 14 is not fixed to the first end part 21 and the connector housing 12, and not restrained by the first end part 21 and the connector housing 12. That is, the clip spring 14 is accommodated in the connector housing 12 without being fixed in position. However, although described later, a displacement of the clip spring 14 in the Y direction is limited (restricted) and the clip spring 14 is positioned in the Z direction by the clip stopper 15.

Here, a connection structure for overlapping and connecting the first end part 21 and the mating end part 92 in the clip spring 14 is described. As described above, the first end part 21 includes the raised portion 21a raised in the Z direction. A first surface (upper surface in FIG. 7) of the mating end part 92 has a convex surface 92a raised toward the first resilient piece 31 in the connected state. A second surface (lower surface in FIG. 7) of the mating end part 92 has a concave surface 92b recessed toward the first resilient piece 31 in the connected state. In the connected state, the raised portion 21a is fit into the concave surface 92b and the convex surface 92a is in contact with the first resilient piece 31. As compared to the non-connected state (FIG. 6), the clip spring 14 is resiliently deformed to enlarge an interval between the first and second resilient pieces 31, 32 in the connected state (FIG. 7). Thus, tightening forces along the Z direction are applied as reaction forces to the overlapped first end part 21 and mating end part 92 by the clip spring 14.

By the connection structure in the clip spring 14 as described above, the mating terminal 91 is hardly detached from the clip spring 14. Further, when the mating terminal 91 is connected to the first end part 21 from the non-connected state (FIG. 6), the clip spring 14 and the first end part 21 are pressed toward the second end part 22 in the Y direction by the mating terminal 91 and start to be displaced. Then, the damper portion 23 is resiliently deformed. Although described later, since a displacement of the clip spring 14 with respect to the first end part 21 is limited by the clip stopper 15, the clip spring 14 is displaced in the Y direction together with the first end part 21. If the first end part 21 is displaced by a predetermined amount, a displacement thereof is limited by the restricting member 13. The restricting member 13 is described later.

Here, the arrangement of the two structures 16, 16 on the both widthwise sides of the connector housing 12 is described with reference to FIG. 3 to describe the clip springs 14. The two clip springs 14, 14 are provided side by side, and the two clip stoppers 15, 15 are also provided side by side for the two structures 16, 16. In the two clip springs 14, 14, the clip base parts 33, 33 are arranged apart on outer sides in the width direction of the connector housing 12. Thus, parts of the clip springs 14 of the respective two structures 16, 16 for sandwiching the first end parts 21 and the mating terminals 91 can be arranged closely in the width direction of the connector housing 12 across the partition wall 53. As a result, the two first end parts 21, 21 can be brought closer to each other and the two mating terminals 91, 91 can be brought close to each other in the width direction, contributing to making the mating connector 90 compact in the width direction.

### Clip Stoppers 15

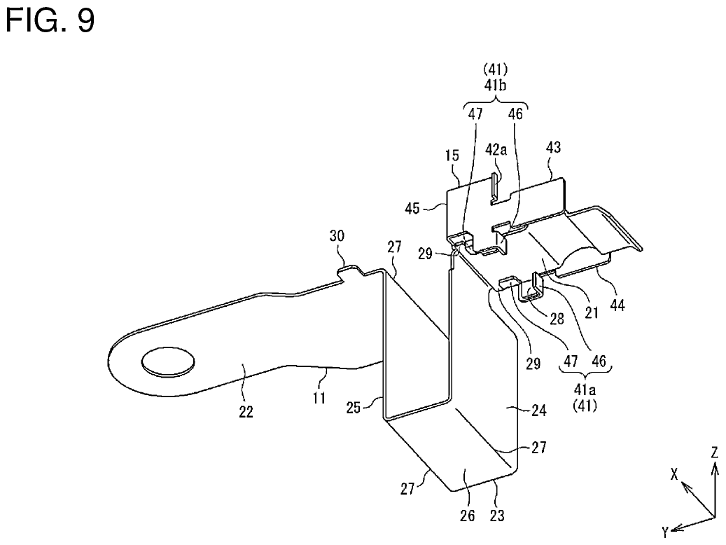

The clip stopper 15 is a member separate from each of the electrically conductive member 11 and the clip spring 14 (see FIG. 5). The clip stopper 15 is made of metal and formed by bending a metal piece. The clip stopper 15 includes a stopper base part 45 located on the Y direction side of the clip spring 14 (see FIG. 4). The stopper base part 45 has a length sufficient to cross over the first end part 21 in the X direction. FIG. 9 is a perspective view of the electrically conductive member 11 and the clip stopper 15. The clip stopper 15 is mounted on the first end part 21 of the electrically conductive member 11 and non-displaceable in the Y direction with respect to the first end part 21. To that end, the clip stopper 15 includes the locking portions 41 to be locked to the first end part 21 of the electrically conductive member 11.

The clip stopper 15 includes a first locking portion 41a to be locked on one side in the width direction of the first end part 21 and a second locking portion 41b to be locked on the other side in the width direction of the first end part 21 as the locking portions 41. The first and second locking portions 41a, 41b are provided on a side (lower side in FIG. 9) opposite to the stopper base part 45 in the Z direction. The first locking portion 41a includes a projecting piece 46 for contacting the first claw portion 28 of the first end part 21 from the Y and X directions and a clamping piece 47 for clamping a part of the first end part 21 in the Z direction. The first and second locking portions 41a, 41b have the same configuration, and the second locking portion 41b also includes a projecting piece 46 and a clamping piece 47. By the first and second locking portions 41a, 41b, the clip stopper 15 is mounted on the first end part 21 non-displaceably in the X, Y and Z directions.

The clip stopper 15 (see FIG. 5) limits a displacement of the clip spring 14 in the Y direction with respect to the first end part 21. To that end, the clip stopper 15 includes stopper portions 42 capable of contacting the clip spring 14 being displaced in the Y direction. In this embodiment, the clip stopper 15 includes first stopper portions 42a capable of contacting the first resilient piece 31 and second stopper portions 42b capable of contacting the second resilient piece 32 as the stopper portions 42. The respective first and second stopper portions 42a, 42b are provided on both sides in the width direction of the stopper base part 45. In this embodiment, the second stopper portion 42b doubles as the projecting piece 46 constituting the locking portion 41.

In the above way, the clip stopper 15 is mounted on the electrically conductive member 11. A displacement of the clip spring 14 with respect to the electrically conductive member 11 is limited by the contact of the clip spring 14 being displaced in the Y direction with the stopper portions 42. The clip stopper 15 has a function of securing a space S (see FIG. 6) for the insertion of the mating terminal 91 between the first and second resilient pieces 31, 32, besides a function of limiting a displacement of the clip spring 14. To that end, the clip stopper 15 (see FIG. 5) includes a first supporting piece 43 located adjacent to the first end part 21 in the width direction. In this embodiment, the clip stopper 15 also includes a second supporting piece 44 located on a side opposite to the first supporting piece 43 across the first end part 21. The first and second supporting pieces 43, 44 have the same shape.

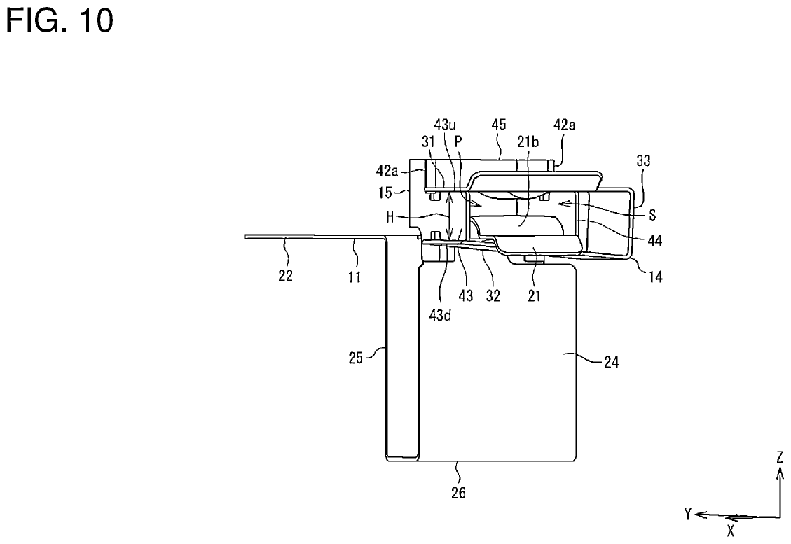

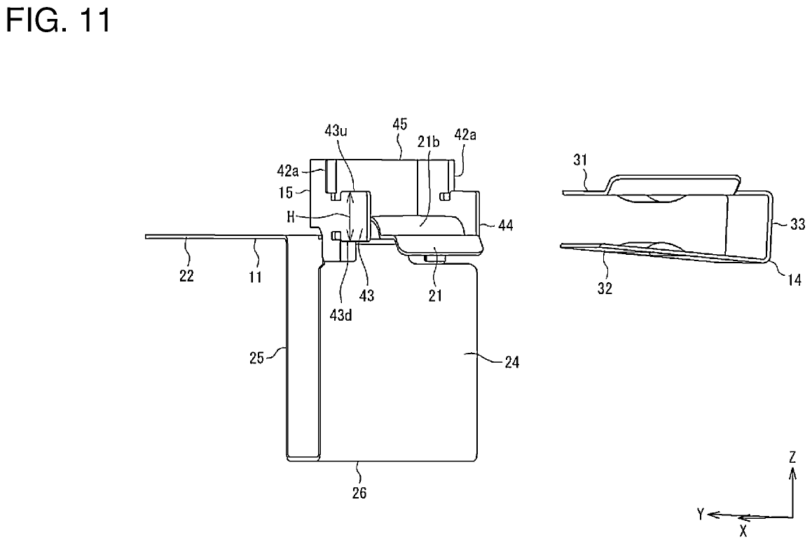

The first supporting piece 43 is provided to extend in the direction opposite to the Y direction from an end on the one side in the width direction of the stopper base part 45. The second supporting piece 44 is provided to extend in the direction opposite to the Y direction from an end on the other side in the width direction of the stopper base part 45. FIG. 10 is a diagram of the clip spring 14 and the clip stopper 15. FIG. 11 is a diagram showing a state where the clip spring 14 is removed from the clip stopper 15. As shown in FIG. 10, the first and second supporting pieces 43, 44 are located between the first and second resilient pieces 31, 32.

A dimension H in the Z direction of the first supporting piece 43 is set to satisfy both of the following first and second conditions.

<First Condition>The dimension H is smaller than a first dimension Z1 in the Z direction of an overlapping part of the first end part 21 and the mating end part 91 overlapped by the clip spring 14 (see FIG. 7).

<Second Condition>The dimension H is larger than a second dimension Z2 in the Z direction of the first end part 21 in a single state (see FIG. 6), out of the overlapping part.

That is, a relationship of the dimension H in the Z direction of the first supporting piece 43 and the first and second dimensions Z1, Z2 is Z2<H<Z1.

Further, as shown in FIG. 10, in a state where the first end part 21 is singly present in the clip spring 14, i.e. in the non-connected state where the first end part 21 and the mating end part 92 are not overlapped, the first and second resilient pieces 31, 32 resiliently sandwich the first supporting piece 43. In other words, in the non-connected state, the first and second resilient pieces 31, 32 are in contact with the first supporting piece 43. Moreover, the first and second resilient pieces 31, 32 are kept forcibly resiliently deformed in directions away from each other by the first supporting piece 43 as compared to the free state.

Out of a clip space P formed between the first and second resilient pieces 31, 32, the first end part 21 is located on a side near the second resilient piece 32. Out of the clip space P, the space S for the insertion of the mating terminal 91 is formed on a side near the first resilient piece 31. That is, a space between the first end part 21 and the first resilient piece 31 serves as the space S for the insertion of the mating terminal 91.

In the non-connected state, the second supporting piece 44 is located between the first and second resilient pieces 31, 32, but not in contact with one or both of these first and second resilient pieces 31, 32. As shown in FIG. 7, in the connected state, the first and second resilient pieces 31, 32 are resiliently deformed in the directions away from each other and not in contact with the first supporting piece 43 unlike in the non-connected state.

As described above (see FIG. 10), the first supporting piece 43 is shaped (to have the dimension H in the Z direction) such that the first resilient piece 31 can contact an end 43u of the first supporting piece 43 in the Z direction and the second resilient piece 32 can contact an end 43d of the first supporting piece 43 on an opposite side in the Z direction. In the non-connected state, the clip spring 14 is positioned in the Z direction by the first supporting piece 43. However, the clip spring 14 is not positioned (not fixed in position) and is slightly displaceable in one or both of the X and Y directions.

As described above, a displacement of the clip spring 14 with respect to the first end part 21 in the Y direction is limited by the clip stopper 15. A displacement of the clip spring 14 toward the opposite side in the Y direction is limited by the wall 54 (see FIG. 4) of the connector housing 12. That is, the connector housing 12 includes a contact portion 59 contactable by the clip spring 14 being displaced toward the opposite side in the Y direction. Thus, the clip spring 14 is not detached toward the opposite side in the Y direction even if the mating terminal 91 is pulled out from the clip spring 14 from the connected state.

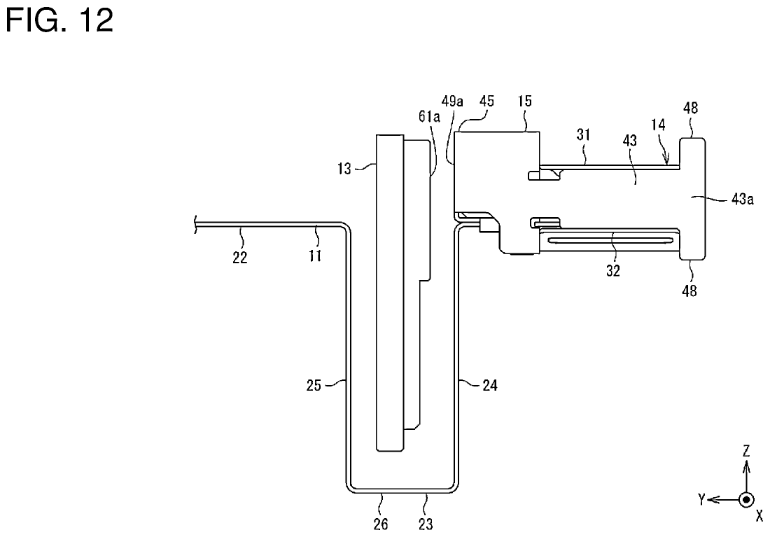

The detachment of the clip spring 14 toward the opposite side in the Y direction may be prevented by the clip stopper 15. FIG. 12 is a diagram showing a modification of the clip stopper 15. This clip stopper 15 includes third stopper portions 48 as detachment preventing stopper portions capable of contacting the clip spring 14 from the Y direction. In a form shown in FIG. 12, the third stopper portions 48 are provided on a tip 43a of the first supporting piece 43. The third stopper portions 48 project toward both sides in the Z direction from the tip 43a of the first supporting piece 43. Third stopper portions 48 are also similarly provided on the second supporting piece 44. In this way, even if the mating terminal 91 is pulled out from the clip spring 14, the clip spring 14 contacts the third stopper portions 48 without contacting the connector housing 12 and is not detached toward the opposite side in the Y direction.

### Restricting Members 13

As shown in FIG. 6, the restricting member 13 is provided in the connector housing 12. In this embodiment, the restricting member 13 is a member separate from the connector housing 12. The restricting member 13 has a plate shape. The restricting member 13 is made of resin and electrically non-conductive. The restricting member 13 is manufactured by injection molding. The restricting member 13 is provided in a region Q formed between the first and second parts 24, 25. The restricting member 13 is so provided in the region Q that a gap e is formed between the restricting member 13 and the first and second parts 24, 25 and the coupling portion 26 in a state where the damping portion 23 of the electrically conductive member 11 is not deformed, i.e. in the free state of the electrically conductive member 11.

As described above (see FIG. 8), the first mounting grooves 56 having the longitudinal direction along the Z direction are formed in the partition wall 53 and the side walls 57, 57 of the connector housing 12. The both side parts 13a of the restricting member 13 are fit into the first mounting grooves 56, 56 facing each other. In this way, the restricting member 13 is mounted in the connector housing 12 non-displaceably in the Y direction and the direction opposite to the Y direction.

As shown in FIG. 6, the restricting member 13 has a first contact surface 61 facing both the clip stopper 15 (stopper base part 45) and the first part 24 of the damper portion 23. In this embodiment, the restricting member 13 is a plate-like member wide in the X and Z directions, but may be narrower in the Z direction than in the shown form. Even in this case, the restricting member 13 preferably has the first contact surface 61 facing at least one of the clip stopper 15 and the first part 14.

Functions of the restricting member 13 are described. As described above, when the mating terminal 91 is inserted through the opening 55 and connected to the first end part 21, the first end part 21 is pushed in the Y direction by the mating terminal 91. The first end part 21 is pushed in the Y direction, whereby the damper portion 23 is resiliently deformed. Then, at least one of the stopper base part 45 of the clip stopper 15 and the first part 24 of the damper portion 23 contacts the first contact surface 61. In this way, a displacement of the first end part 21 when the damper portion 23 is resiliently deformed is limited. That is, a resilient deformation amount of the damper portion 23 is limited. As a result, the first end part 21 hardly escapes even if being pushed in the Y direction, and the first end part 21 and the mating terminal 91 are easily connected.

As just described, the restricting member 13 is provided in the region Q adjacent to the first end part 21 in the Y direction to limit the displacement of the first end part 21 when the damper portion 23 is resiliently deformed. In the free state of the electrically conductive member 11, the restricting member 13 is provided in the region Q with a gap formed between the restricting member 13 and the clip stopper 15 (stopper base part 45) and the first part 24 serving as contact partners.

The first contact surface 61 is further described. The first contact surface 61 has a first surface part 61a along a virtual plane in an X-Z direction. The clip stopper 15 (stopper base part 45) as a candidate for the contact partner has a second contact surface 49 facing the first contact surface 61. The second contact surface 49 has a second surface part 49a along another virtual plane in the X-Z direction. As described above, to sandwich and connect the first end part 21 and the mating terminal 91 by the clip spring 14, the damper portion 23 is resiliently deformed by the mating terminal 91 pushing the first end part 21. Then, at least one of the first surface part 49a and the first part 24 contacts the first surface part 61a. The first surface part 61a along the virtual plane and the second surface part 49a along the virtual plane can come into surface contact in some cases.

In the form shown in FIG. 6, the first contact surface 61 of the restricting member 13 has the first surface part 61a along the virtual plane in the X-Z direction. The contact partner (e.g. the clip stopper 15) contacts a part of the first surface part 61a of the first contact surface 61. According to this configuration, if the contact partner approaches and contacts the first contact surface 61 from the Y direction, the restricting member 13 can stably support that contact partner. As a result, ease of connection of the first end part 21 and the mating terminal 91 is improved.

### Modifications of Restricting Member 13

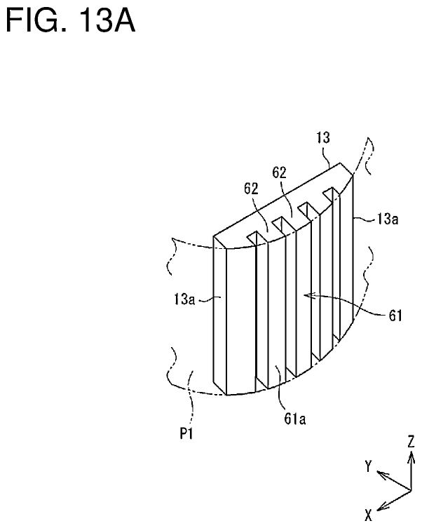

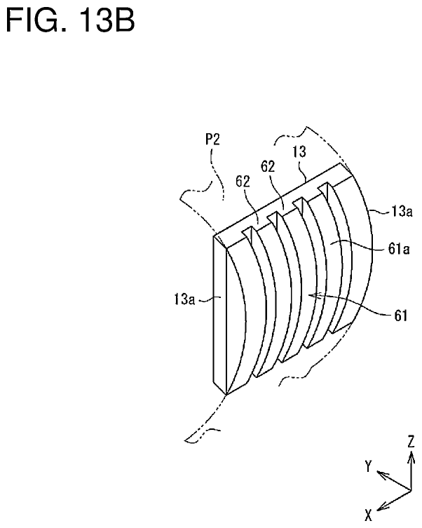

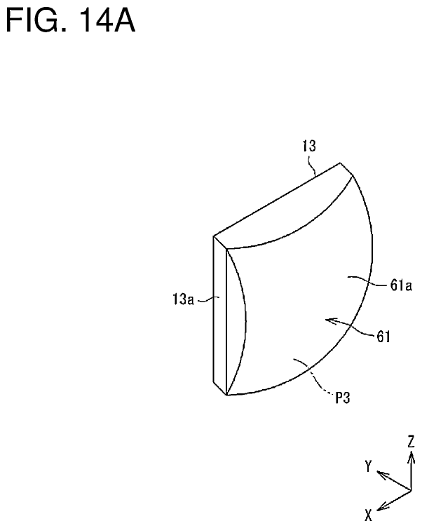

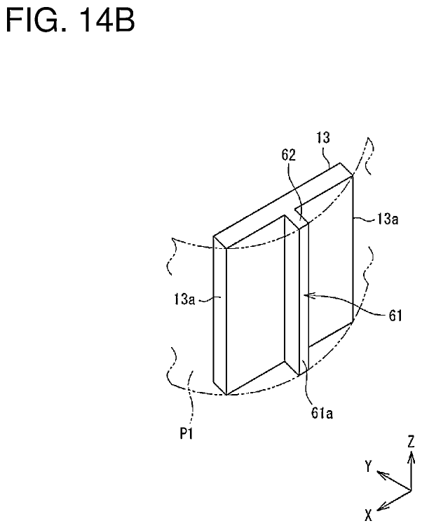

FIGS. 13A, 13B, 14A and 14B are perspective views showing modifications of the restricting member 13. A first modification shown in FIG. 13A is described. The first contact surface 61 of the restricting member 13 has a first surface part 61a along a virtual curved surface P1 convex toward the opposite side in the Y direction. In the first modification, a cross-sectional shape is constant without changing in the Z direction in a part of the restricting member 13 including the first contact surface 61. In the first modification, the restricting member 13 includes a plurality of ridges 62 having a longitudinal direction along the Z direction. A surface of each ridge 62 on the opposite side in the Y direction has a shape along the virtual curved surface P1. Thus, the first surface part 61a is a surface having a protruded and recessed shape along the virtual curved surface P1. Since the restricting member 13 has the surface having the protruded and recessed shape, molding failures such as sinks (dents) can be suppressed when the restricting member 13 is injection-molded.

Note that the entire first surface part 61a may be a smooth curved surface without having the protruded and recessed shape. Alternatively, the restricting member 13 may include the plurality of ridges 62 having the longitudinal direction along the Z direction and a plurality of unillustrated ridges having a longitudinal direction along the X direction, and the first surface part 61a may be a lattice-shaped surface along the virtual curved surface P1. Alternatively, the restricting member 13 may include only ridges long in the X direction.

A second modification shown in FIG. 13B is described. The first contact surface 61 of the restricting member 13 has a first surface part 61a along a virtual curved surface P2 convex toward the opposite side in the Y direction. In the second modification, a cross-sectional shape is constant without changing in the X direction in a part of the restricting member 13 including the first contact surface 61. In the second modification, the restricting member 13 includes a plurality of ridges 62 having a longitudinal direction along the Z direction and a surface of each ridge 62 on the opposite side in the Y direction has a shape along the virtual curved surface P2. Thus, the first surface part 61a is a surface having a protruded and recessed shape along the virtual curved surface P2.

Note that the entire first surface part 61a may be a smooth curved surface without having the protruded and recessed shape also in the second modification. Alternatively, the restricting member 13 may include the plurality of ridges 62 having the longitudinal direction along the Z direction and a plurality of unillustrated ridges having a longitudinal direction along the X direction, and the first surface part 61a may be a lattice-shaped surface along the virtual curved surface P2. Alternatively, the restricting member 13 may include only ridges long in the X direction.

A third modification shown in FIG. 14A is described. The first contact surface 61 of the restricting member 13 has a first surface part 61a along a virtual curved surface P3 convex toward the opposite side in the Y direction. The curved surface P3 is a surface along a spherical surface. Although the ridges 62 as in the first modification are not provided in the third modification, the ridges 62 may be provided.

A fourth modification shown in FIG. 14B is described. The fourth modification differs from the first modification in the number of the ridges 62. In the fourth modification, one ridge 62 is provided in a central part in the X direction. A surface of that ridge 62 on the opposite side in the Y direction is a first surface part 61a and has a shape along the virtual curved surface P1. That is, also in the fourth modification, the first contact surface 61 has the first surface part 61a along the virtual curved surface P1. Note that although one ridge 62 is provided in the fourth modification, two or more ridges may be provided. However, the ridges 62 are not provided entirely in the X direction, but provided in a part (central part) in the X direction.

As described above, in the restricting member 13 of each of the first to fourth modifications, the first contact surface 61 has the first surface part 61a along the curved surface and a part of the first surface part 61a of the first contact surface 61 contacts the contact partner. In this case, even if the contact partner approaches and contacts the restricting member 13 in an inclined posture, the restricting member 13 can stably support the contact partner. As a result, ease of connection of the first end part 21 and the mating terminal 91 is improved.

### Connector 10 According to Each Embodiment

As described above, the connector 10 of each embodiment is a connector electrically connectable to the mating connector 90 provided with the mating terminals 91 as shown in FIGS. 1 and 2. As shown in FIG. 4, the connector 10 is provided with the strip-like electrically conductive members 11 including the first end parts 21 connectable to the mating terminals 91, the connector housing 12 for accommodating the electrically conductive members 11, the clip springs 14 and the clip stoppers 15. The clip spring 14 is a member separate from the electrically conductive member 11 and accommodates the first end part 21. The clip stopper 15 is mounted on the electrically conductive member 11 and limits a displacement of the clip spring 14 with respect to the electrically conductive member 11. The clip spring 14 is accommodated in the connector housing 12 without being fixed in position.

The connector housing 12 includes the wall 54 provided with the openings 55 enabling the insertion of the mating terminals 91 in the Y direction to connect the mating terminals 91 to the first end parts 21 (see FIG. 2). The clip spring 14 includes the first and second resilient pieces 31, 32. With the mating terminal 91 inserted through the opening 55 overlapped on the first end part 21, the first and second resilient pieces 31, 32 can sandwich the first end part 21 and the mating terminal 91. As shown in FIG. 5, the clip stopper 15 includes the locking portions 41 to be locked to the electrically conductive member 11 and the stopper portions 42 capable of contacting the clip spring 14 being displaced in the Y direction.

According to the connector 10 of each embodiment, the first end part 21 of the electrically conductive member 11 is accommodated in the clip spring 14 and the mating terminal 91 is inserted through the opening 55 of the connector housing 12 to be connected to the first end part 21. At that time, even if there is a slight positional deviation, for example, in the Z direction, between the first end part 21 and the mating terminal 91, a part of the strip-like electrically conductive member 11 can absorb such a positional deviation by being resiliently deformed. Further, since the clip spring 14 is a member separate from the electrically conductive member 11 and not fixed in position, the first end part 21 and the mating terminal 91 can be connected by absorbing the positional deviation.

Further, the mating terminal 91 is brought closer to and brought into contact with the clip spring 14 through the opening 55 along the Y direction to be connected to the first end part 21 accommodated in the clip spring 14. Then, the clip spring 14 is displaced in the Y direction. The clip stopper 15 is locked to the electrically conductive member 11 by the locking portions 41 and non-displaceable in the Y direction with respect to the electrically conductive member 11, and the clip spring 14 contacts the stopper portions 42 of the clip stopper 15. As a result, the clip spring 14 does not escape in the Y direction and the first end part 21 and the mating terminal 91 are easily connected.

The clip stopper 15 includes the first stopper portions 42a capable of contacting the first resilient piece 31 and the second stopper portions 42b capable of contacting the second resilient piece 32 as the stopper portions 42. By this configuration, at the time of connecting the first end part 21 and the mating terminal 91, the clip stopper 15 contacts both the first and second resilient pieces 31, 32 of the clip spring 14 and the posture of the clip spring 14 hardly changes. The first end part 21 and the mating terminal 91 are more easily connected.

The clip stopper 15 includes the first locking portion 41a to be locked to the one side in the width direction of the electrically conductive member 11 and the second locking portion 41b to be locked to the other side in the width direction of the electrically conductive member 11. By this configuration, the clip stopper 15 is hardly inclined with respect to the electrically conductive member 11 and the clip spring 14 can be stably supported.

The clip stopper 15 includes the first supporting piece 43. The first supporting piece 43 is located between the first and second resilient pieces 31, 32 and adjacent to the first end part 21 in the width direction. As shown in FIG. 10, the first resilient piece 31 can contact the one end 43u of the first supporting piece 43, and the second resilient piece 32 can contact the other end 43d of the first supporting piece 31. The first end part 21 is located on the side near the second resilient piece 32, out of the clip space P formed between the first and second resilient pieces 31, 32. The space S for the insertion of the mating terminal 91 is located on the side near the first resilient piece 31, out of the clip space P. By this configuration, the space S for the insertion of the mating terminal 91 is formed between the first end part 21 and the first resilient piece 31 by the first supporting piece 43. With the mating terminal 91 overlapped on and connected to the first end part 21, the first resilient piece 31 is in contact with the mating terminal 91, the second resilient piece 32 is in contact with the first end part 21 and the clip spring 14 sandwiches the first end part 21 and the mating terminal 91.

As described with reference to FIGS. 10 and 11, the dimension H in the Z direction of the first supporting piece 43 is set to satisfy the first and second conditions. In the state where the mating terminal 91 is not overlapped on the first end part 21, the first and second resilient pieces 31, 32 resiliently sandwich the first supporting piece 43.

According to the first condition, the dimension H in the Z direction of the first supporting piece 43 is smaller than the first dimension Z1 of the first end part 21 and the mating end part 92 in the overlapped state. Thus, the first end part 21 and the mating end part 92 are resiliently sandwiched by the first and second resilient pieces 31, 32.

According to the second condition, the dimension H in the Z direction of the first supporting piece 43 is larger than the second dimension Z2 of the first end part 21 in the single state. In the non-connected state where the mating terminal 91 is not overlapped on the first end part 21, the first and second resilient pieces 31, 32 resiliently sandwich the first supporting piece 43. Thus, the space S for the insertion of the mating terminal 91 to be overlapped on the first end part 21 is secured between the first and second resilient pieces 31, 32. Therefore, a force required to insert and mount the mating terminal 91 into the clip spring 14 is reduced.

As shown in FIG. 3, one pair of the structures 16 each including the electrically conductive member 11, the clip spring 14 and the clip stopper 15 are plane-symmetrically arranged with respect to the center C in the width direction of the connector housing 12 on the both sides in the width direction of the connector housing 12. By this configuration, the clip stopper 15 can be used as a common component for each of the pair of structures 16, 16 arranged on the both widthwise sides of the connector housing 12. Further, the clip spring 14 can also be used as a common component.

The electrically conductive member 11 includes the first end part 21, the second end part 22 located on the side opposite to the first end part 21 in the longitudinal direction of the electrically conductive member 11 and the damper portion 23 provided between the first and second end parts 21, 22. The damper portion 23 is resiliently deformable at least in the direction to bring the first and second end parts 21, 22 toward each other. The damper portion 23 is resiliently deformable also in the Z direction. By this configuration, even if there is a positional deviation, for example, in the Z direction between the first end part 21 and the mating terminal 91 when the mating terminal 91 inserted through the opening 55 of the connector housing 12 is connected to the first end part 21 of the electrically conductive member 11, such a positional deviation can be absorbed by the resilient deformation of the damper portion 23.

The connector 10 is further provided with the restricting members 13 provided in the connector housing 12. The restricting member 13 is provided in the region Q adjacent to the first end part 21 in the Y direction (to have the gap e between the damper portion 23 and the restricting member 13) to limit a displacement of the first end part 21 when the damper portion 23 is resiliently deformed. By this configuration, a displacement of the first end part 21 is limited by the restricting member 13 provided in the region Q adjacent to the first end part 21. Thus, a resilient deformation amount of the damper portion 23 caused by a force for mechanically connecting the first end part 21 and the mating terminal 91 is limited. As a result, the clip spring 14 does not escape in the Y direction and the first end part 21 and the mating terminal 91 are easily connected.

### Other Embodiments

Although the electrically conductive member 11 is constituted by the single strip piece in this embodiment, the electrically conductive member 11 may have another form and may be configured by combining a plurality of strip pieces. Although the damper portion 23 is described to include the first and second parts 24, 25 having a flat plate shape and the coupling portion 26 coupling the first and second parts 24, 25, the damper portion 23 may have another form.

The clip stopper 15 may also have another form and, for example, the second supporting piece 44 may be omitted. Further, the clip stopper 15 may contact at least one of the first and second resilient pieces 31, 32 of the clip spring 14. Further, the clip spring 14 may also have another form.

The first and second structures 16, 16 may not be plane-symmetrically arranged as in the above embodiment. Further, the first and second structures 16, 16 may be partially different.

The above embodiment is illustrative in all aspects, rather than restrictive. The scope of a right of the present invention is represented not by the above embodiment, but by claims and includes all changes in the scope of claims and in the meaning and scope of equivalents.

### LIST OF REFERENCE NUMERALS

5 first electrical device
6 second electrical device
10 connector
11 electrically conductive member
12 connector housing
13 restricting member
13a side part
14 clip spring
14 clip stopper
16 structure
21 first end part
21b first body portion
21c first fixing portion
21a raised portion
22 second end part
22b second body portion
22c second fixing portion
23 damper portion
24 first part
25 second part
26 coupling portion
27 bent portion
28 first claw portion
29 second claw portion
30 third claw portion
31 first resilient piece
32 second resilient piece
33 clip base part
41 locking portion
41a first locking portion
41b second locking portion
42 stopper portion
42a first stopper portion
42b second stopper portion
43 first supporting piece
43u end
43d end
44 second supporting piece
45 stopper base part
46 projecting piece
47 clamping piece
48 third stopper portion
49 second contact surface
49a second surface part
51 housing body
52 cover
52a one part
53 partition wall
54 wall
55 opening
56 second mounting groove (groove)
57 side wall
58 second mounting groove
59 contact portion
61 first contact surface
61a first surface part
62 ridge
90 mating connector
91 mating terminal
92 mating end part
92a convex surface
92b concave surface
93 mating housing
K1 first space
K2 second space
P1 curved surface
P2 curved surface
P3 curved surface
Z1 first dimension
Z2 second dimension

1. A connector electrically connectable to a mating connector provided with a mating terminal, comprising:
a strip-like electrically conductive member including a first end part connectable to the mating terminal;
a connector housing for accommodating the electrically conductive member;
a clip spring separate from the electrically conductive member, the clip spring accommodating the first end part; and
a clip stopper mounted on the electrically conductive member, the clip stopper limiting a displacement of the clip spring with respect to the electrically conductive member,
the connector housing including a wall provided with an opening enabling insertion of the mating terminal in a first direction along a longitudinal direction of the electrically conductive member to connect the mating terminal to the first end part,
the clip spring including a first resilient piece and a second resilient piece capable of sandwiching the first end part and the mating terminal with the mating terminal inserted through the opening overlapped on the first end part, and
the clip stopper including a locking portion to be locked to the electrically conductive member and a stopper portion capable of contacting the clip spring being displaced in the first direction.

2. The connector of claim 1, wherein the clip stopper includes a first stopper portion capable of contacting the first resilient piece and a second stopper portion capable of contacting the second resilient pieces as the stopper portions.

3. The connector of claim 1, wherein the clip stopper includes a first locking portion to be locked on one side in a width direction orthogonal to the first direction and a second locking portion to be locked on the other side in the width direction as the locking portions.

4. The connector of claim 1, wherein:
the clip stopper includes a first supporting piece located between the first and second resilient pieces and adjacent to the first end part in a width direction orthogonal to the first direction, and
if a direction of overlapping the first end part and the mating terminal in the clip spring is an overlapping direction,
the first resilient piece is capable of contacting one end in the overlapping direction of the first supporting piece,
the second resilient piece is capable of contacting the other end in the overlapping direction of the first supporting piece,
the first end part is located on a side near the second resilient piece, out of a clip space formed between the first and second resilient pieces, and
an space for insertion of the mating terminal is formed on a side near the first resilient piece, out of the clip space.

5. The connector of claim 4, wherein:
a dimension in the overlapping direction of the first supporting piece is smaller than a first dimension in the overlapping direction of the first end part and the mating terminal overlapped by the clip spring and larger than a second dimension in the overlapping direction of the first end part in a single state, and
the first and second resilient pieces resiliently sandwich the first supporting piece in a state where the mating terminal is not overlapped on the first end part.

6. The connector of claim 4, wherein:
the clip spring includes a clip base part located adjacent to the first end part in the width direction,
the first and second resilient pieces are respectively provided to extend in the width direction from both ends in the overlapping direction of the clip base part,
the clip stopper includes a stopper base part located on the first direction side of the clip spring and a second supporting piece located on a side opposite to the first supporting piece across the first end part,
the first and second supporting pieces are respectively provided to extend in a direction opposite to the first direction from both ends in the width direction of the stopper base part, and
a pair of structures each including the electrically conductive member, the clip spring and the clip stopper are plane-symmetrically arranged with respect to a center in the width direction of the connector housing on both sides in the width direction of the connector housing.

7. The connector of claim 6, wherein the clip base parts are arranged apart on outer sides in the width direction in two structures arranged on the both sides in the width direction of the connector housing.

8. The connector of claim 1, wherein the clip stopper includes a detachment preventing stopper portion capable of contacting the clip spring from the first direction.

9. The connector of claim 1, wherein the electrically conductive member includes:
a second end part located on a side opposite to the first end part in the longitudinal direction of the electrically conductive member; and
a damper portion provided between the first and second end parts, the damper portion being resiliently deformable in a direction to bring the first and second end parts closer.

10. The connector of claim 9, further comprising a restricting member provided in the connector housing, wherein:
the restricting member is provided in a region adjacent to the first end part in the first direction to limit a displacement of the first end part when the damper portion is resiliently deformed.
